(19) United States
(12) Patent Application Publication
(10) Pub. No.: US 2014/0340912 A1
(43) Pub. Date: Nov. 20, 2014

(54) TRANSPARENT LIGHT-EMITTING SHEET AND METHOD OF MANUFACTURING SAME

(71) Applicants: Dongwon Kang, Gwangmyeong-si (KR); Dongseon Jang, Gapyeong-Gun (KR); Gunyoung Hong, Seoul (KR)

(72) Inventors: Dongwon Kang, Gwangmyeong-si (KR); Dongseon Jang, Gapyeong-Gun (KR); Gunyoung Hong, Seoul (KR)

(73) Assignee: LG ELECTRONICS INC., Seoul (KR)

(21) Appl. No.: 14/344,295

(22) PCT Filed: Sep. 5, 2012
(86) PCT No.: PCT/KR2012/007105

§ 371 Date: Mar. 11, 2014

(30) Foreign Application Priority Data
Oct. 17, 2011 (KR) 10-2011-0106130

(51) Int. Cl. F21V 9/00; C23C 28/00; C25D 11/04

(52) U.S. Cl. CPC F21V 9/00; C25D 11/04; C23C 28/00
USPC 362/351; 205/112

(57) ABSTRACT

The present invention relates to a transparent light-emitting sheet which obtains high color purity and improves light collimation to improve light efficiency, and a method of manufacturing same. The transparent light-emitting sheet according to an embodiment of the present invention includes: a transparent alumina sheet having a plurality of nanopores that are uniformly aligned; and luminescent nanoparticles that are respectively disposed within the plurality of nanopores and convert wavelengths of excitation light to generate wavelength-converted light.

### TECHNICAL FIELD

The present disclosure relates to a transparent light-emitting sheet and a method of manufacturing the same.

### BACKGROUND ART

In general, most of light emitting diodes (LEDs) emit light similar to monochromatic light, unlike diodes having wide light-emitting spectra, such as incandescent bulbs. Each LED generates different energy according to its electron/hole coupling, and thus emits red, green, blue or yellow light according to each characteristic.

### DISCLOSURE OF THE INVENTION

Therefore, to obviate those problems, an aspect of the detailed description is to provide a transparent light-emitting sheet, capable of obtaining light with high color purity and improving collimation of light so as to enhance light efficiency.

To achieve these and other advantages and in accordance with the purpose of the present invention, as embodied and broadly described herein, there is provided a transparent light-emitting sheet including a transparent alumina sheet having a plurality of nanopores which are uniformly aligned, and luminescent nanoparticles that are respectively disposed within the plurality of nanopores and covert wavelengths of excitation light to generate wavelength-converted light.

In accordance with one exemplary embodiment disclosed herein, the luminescent nanoparticles may be quantum dots.

In accordance with one exemplary embodiment disclosed herein, the plurality of nanopores may have a uniform size, a uniform shape and a uniform arrangement.

In accordance with one exemplary embodiment disclosed herein, each of the plurality of nanopores may have one of circular, rectangular and hexagonal shapes.

In accordance with one exemplary embodiment disclosed herein, the plurality of nanopores may be formed in such a manner of anodizing an aluminum thin film in an electrolytic acid solution containing oxide.

In accordance with one exemplary embodiment disclosed herein, one quantum dot may be formed within each nanopore of the transparent alumina sheet.

To achieve these and other advantages and in accordance with the purpose of the present invention, as embodied and broadly described herein, there is provided a method for manufacturing a transparent light-emitting sheet, including producing a transparent alumina sheet having a plurality of nanopores in a manner of anodizing an aluminum thin film in an electrolytic acid solution, filling a predetermined amount of luminescent precursors within the plurality of pores, and generating quantum dots by applying heat to the luminescent precursors filled in the plurality of pores.

### ADVANTAGEOUS EFFECT

In a transparent light-emitting sheet and a manufacturing method thereof according to one exemplary embodiment, quantum dots with the same size may be generated in a plurality of nanopores of a transparent alumina sheet, respectively, thereby obtaining light with high color purity.

In the transparent light-emitting sheet and the manufacturing method thereof according to the one exemplary embodiment, use of a transparent alumina sheet may allow for manufacturing a transparent light-emitting sheet (or film) without an additional process (for example, a semiconductor process) and for solving an aggregation of the quantum dots, which is caused upon distributing the quantum dots in polymers.

In the transparent light-emitting sheet and the manufacturing method thereof according to the one exemplary embodiment, light generated by the quantum dots may be transmitted through the nanopores, which may improve collimation of light, thereby enhancing light efficiency.

### BRIEF DESCRIPTION OF THE DRAWINGS

FIG. 1 is a configuration view of a transparent light-emitting sheet in accordance with one exemplary embodiment disclosed herein.

FIG. 2 is a sectional view of the transparent light-emitting sheet, taken along the line A-A′.

FIG. 3 is a flowchart illustrating a method of manufacturing a transparent light-emitting sheet in accordance with one exemplary embodiment disclosed herein.

FIGS. 4 to 6 are views illustrating a process of generating quantum dots in accordance with the one exemplary embodiment disclosed herein.

### MODES FOR CARRYING OUT THE PREFERRED EMBODIMENTS

It should be noted that technological terms used herein are merely used to describe a specific embodiment, but not to limit the present invention. Also, unless particularly defined otherwise, technological terms used herein should be construed as a meaning that is generally understood by those having ordinary skill in the art to which the invention pertains, and should not be construed too broadly or too narrowly. Furthermore, if technological terms used herein are wrong terms unable to correctly express the spirit of the invention, then they should be replaced by technological terms that are properly understood by those skilled in the art. In addition, general terms used in this invention should be construed based on the definition of dictionary, or the context, and should not be construed too broadly or too narrowly.

Incidentally, unless clearly used otherwise, expressions in the singular number include a plural meaning. In this application, the terms “comprising” and “including” should not be construed to necessarily include all of the elements or steps disclosed herein, and should be construed not to include some of the elements or steps thereof, or should be construed to further include additional elements or steps.

Furthermore, the terms including an ordinal number such as first, second, etc. can be used to describe various elements, but the elements should not be limited by those terms. The terms are used merely for the purpose to distinguish an element from the other element. For example, a first element may be named to a second element, and similarly, a second element may be named to a first element without departing from the scope of right of the invention.

Hereinafter, preferred embodiments of the present invention will be described in detail with reference to the accompanying drawings, and the same or similar elements are designated with the same numeral references regardless of the numerals in the drawings and their redundant description will be omitted.

In describing the present invention, moreover, the detailed description will be omitted when a specific description for publicly known technologies to which the invention pertains is judged to obscure the gist of the present invention. Also, it should be noted that the accompanying drawings are merely illustrated to easily explain the spirit of the invention, and therefore, they should not be construed to limit the spirit of the invention by the accompanying drawings.

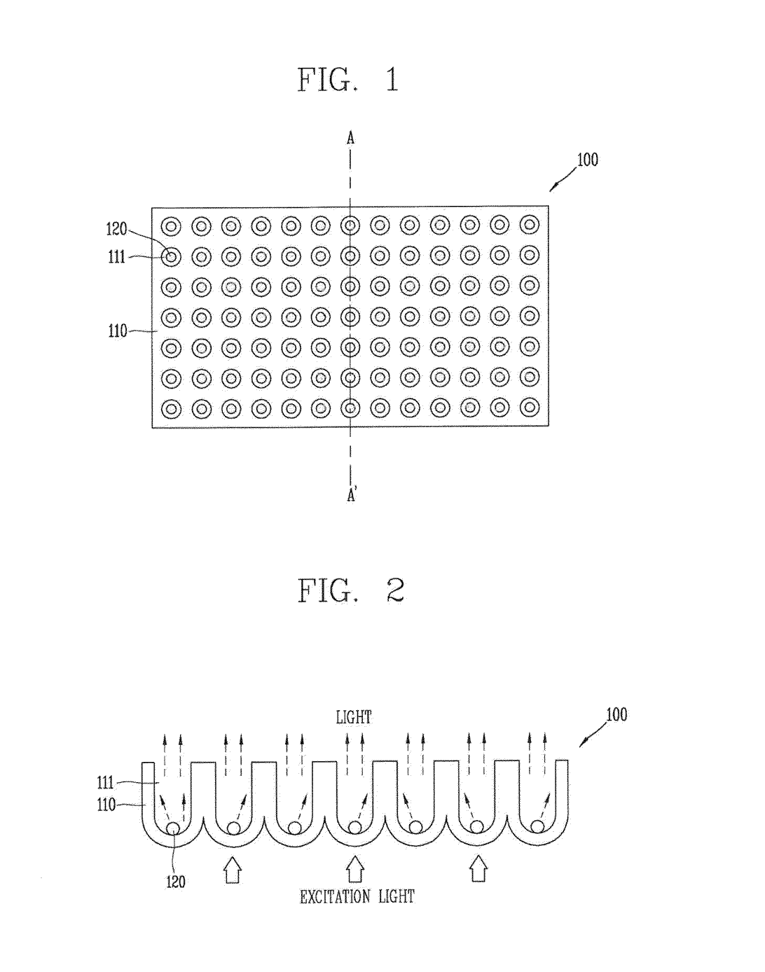

Hereinafter, description will be given of a transparent light-emitting sheet, which is capable of being applied to various types of display devices, such as liquid crystal display (LCD) devices, organic light emitting diode (OLED) devices, LED devices and the like, and a manufacturing method thereof, with reference to FIGS. 1 to 6.

FIG. 1 is a configuration view of a transparent light-emitting sheet in accordance with one exemplary embodiment disclosed herein.

As illustrated in FIG. 1, a transparent light-emitting sheet 100 in accordance with one exemplary embodiment disclosed herein may include an transparent alumina sheet 110 having a plurality of nanopores 111 which are uniformly aligned, and quantum dots (or luminescent nanoparticles) 120 located within the plurality of nanopores 111, respectively, and configured to generate wavelength-converted light by converting wavelengths of excitation light (for example, light generated by a blue LED). The nanopore 111 may have a variety of shapes, such as a circular shape, a rectangular shape, a hexagonal shape and the like.

The quantum dot may be a nano-sized luminous object with a diameter less than 10 nm. The quantum dot may be a material which provides a quantum confinement effect. As compared with typical fluorescent substances, the quantum dot emits stronger light within a narrow wavelength range. The light emission of the quantum dot is generated as electrons in an excited state transit from a conduction band into a valence band. And, for the same material, the quantum dot may exhibit a characteristic of emitting light with a different wavelength according to a size of particle. Light with shorter wavelength is generated when the quantum dot is smaller in size, and thus light in a desired wavelength range can be obtained by adjusting the size of the quantum dot. As the quantum dot, CdSe/ZnS core/shell quantum dot may be used.

The quantum dot emits light even when an excitation wavelength (or excitation light) is randomly selected. Hence, when various types of quantum dots are excited using one wavelength, several colors of light may be observed at once.

The quantum dot may be fabricated by a vapor deposition method, such as metal organic chemical vapor deposition (MOCVD) or molecular beamepitaxy (MBE), or by chemical wetting of growing crystals by putting precursors into an organic solvent.

On the other hand, when the quantum dots are distributed in polymers and coated on a transparent substrate, such as glass, the quantum dots may be aggregated, which may lower uniformity of light. However, a transparent light-emitting sheet 100 may be manufactured by growing the quantum dots (or luminescent nanoparticles) within a plurality of nanopores which are uniformly aligned, so as to be used instead of the conventional non-transparent (or opaque) fluorescent film (screen). This may result in an increase in color conversion efficiency.

The transparent light-emitting sheet 100 according to the one exemplary embodiment may be manufactured in a manner of growing one quantum dot in each nanopore, which has a uniform size, a uniform shape, and a uniform arrangement, which may prevent lowering of efficiency of the quantum dot itself, due to aggregation and re-adsorption.

The transparent light-emitting sheet 100 according to the one exemplary embodiment may have quantum dots with a uniform size, in view of growing one quantum dot within each uniform-sized nanopore.

The transparent light-emitting sheet (film) 100 according to the one exemplary embodiment may be manufactured, without an additional process, by virtue of using a transparent alumina sheet.

The transparent light-emitting sheet 100 according to the one exemplary embodiment may enhance light efficiency by improving collimation of light, in a manner of allowing light generated by the quantum dots to be transmitted through the nanopores 111 of the transparent alumina sheet 110.

FIG. 2 is a sectional view of the transparent light-emitting sheet, taken along the line A-A′.

As illustrated in FIG. 2, after growing one quantum dot 120 within each nanopore 111, which is formed on the transparent alumina sheet 110 to be uniform in size, shape and arrangement, when excitation light is applied to the nanopore 111, the excitation light may be incident onto the quantum dot 120 through the transparent nanopore. The quantum dot 120 may then convert a wavelength of the excitation light (for example, a blue LED), thereby generating wavelength-converted light.

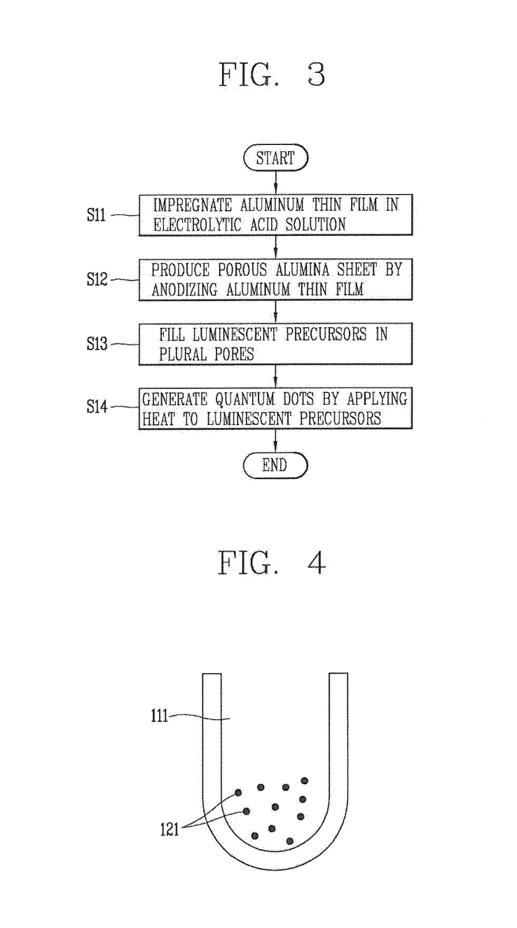

FIG. 3 is a flowchart illustrating a method of manufacturing a transparent light-emitting sheet in accordance with one exemplary embodiment disclosed herein.

First, an aluminum thin film may be impregnated in an electrolytic acid solution which contains oxide, such as H₂SO₄, C₂H₂O₂, H₃PO₄ and the like (S11).

The aluminum thin film may be anodized in the electrolytic acid solution, thereby manufacturing the transparent alumina sheet 110, which has a plurality of nanopores with a uniform size, a uniform shape and a uniform arrangement (S12). Size and height of the nanopore may be adjustable by an anodization time, a voltage, an electrolytic solution and the like.

The aluminum thin film may be anodized in the electrolytic acid solution, thereby manufacturing the transparent alumina sheet 110, which has a plurality of nanopores having one of a uniform size, a uniform shape and a uniform arrangement.

A predetermined amount of luminescent precursors 121 may be filled in the plurality of nanopores (S13). The size of the quantum dot may differ according to the amount of the luminescent precursors.

FIGS. 4 to 6 are views illustrating a process of generating the quantum dots in accordance with the one exemplary embodiment disclosed herein.

As illustrated in FIG. 4, the predetermined amount of luminescent precursors 121 may be filled in each of the pores 111. The size of the quantum dot may be decided according to the amount of luminescent precursors 121 filled in the pore 111.

Heat may be applied to the luminescent precursors filled in the plurality of pores so as to generate the quantum dots (S14).

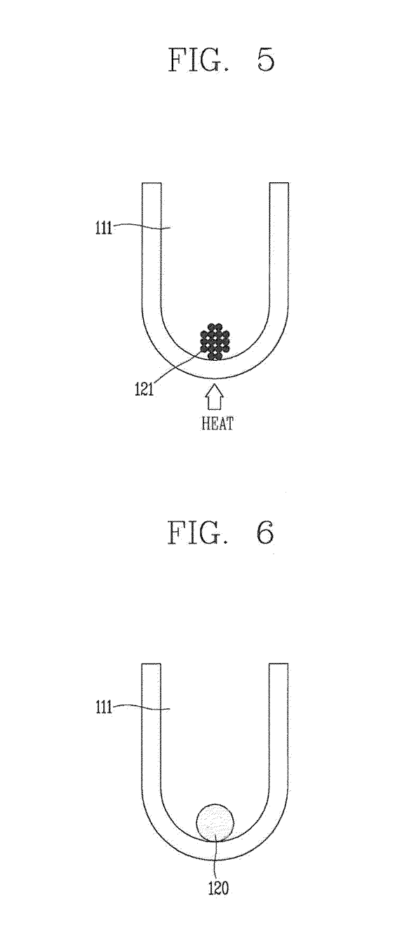

As illustrated in FIGS. 5 and 6, after the predetermined amount of luminescent precursors 121 is filled in each pore 111, when the heat is applied to the luminescent precursors 121, the luminescent precursors 121 may be slowly aggregated into one quantum dot. When the heat is applied to the luminescent precursors filled in the nanopores with the uniform size, the quantum dots with a uniform size may be generated, by virtue of the uniform size of each nanopore. That is, the quantum dots with the same size may be generated by filling the uniform amount of luminescent precursors in a reaction space (i.e., each nanopore) having a limited space and uniformity. Here, one quantum dot may be generated in one nanopore by applying heat to the luminescent precursors filled in the one pore.

### INDUSTRIAL APPLICABILITY

As described above, in a transparent light-emitting sheet and a manufacturing method thereof according to one exemplary embodiment, quantum dots with the same size may be generated in a plurality of nanopores of a transparent alumina sheet, respectively, thereby obtaining light with high color purity.

In the transparent light-emitting sheet and the manufacturing method thereof according to the one exemplary embodiment, use of a transparent alumina sheet may allow for manufacturing a transparent light-emitting sheet (or film) without an additional process (for example, a semiconductor process) and for solving an aggregation of the quantum dots, which is caused upon distributing the quantum dots in polymers.

In the transparent light-emitting sheet and the manufacturing method thereof according to the one exemplary embodiment, light generated by the quantum dots may be transmitted through the nanopores, which may improve collimation of light, thereby enhancing light efficiency.

It may be obvious to those skilled in the art that various modifications and changes can be embodied without departing from the features of the present disclosure. Therefore, the foregoing embodiments are merely illustrative without limiting the technical scope of the present disclosure, and the technical scope of the present disclosure may not be limited by the foregoing embodiments. The bounds of the present application should be construed by the following claims, and every technical idea within the equivalents should be constructed to be included in the claims of the present disclosure.

1. A transparent light-emitting sheet comprising:
a transparent alumina sheet having a plurality of nanopores which are uniformly aligned; and
luminescent nanoparticles that are respectively disposed within the plurality of nanopores and covert wavelengths of excitation light to generate wavelength-converted light.

2. The transparent light-emitting sheet of claim 1, wherein the luminescent nanoparticles are quantum dots.

3. The transparent light-emitting sheet of claim 1, wherein the plurality of nanopores have a uniform size, a uniform shape and a uniform arrangement.

4. The transparent light-emitting sheet of claim 1, wherein the plurality of nanopores have one of a uniform size, a uniform shape and a uniform arrangement.

5. The transparent light-emitting sheet of claim 1, wherein each of the plurality of nanopores has one of circular, rectangular and hexagonal shapes.

6. The transparent light-emitting sheet of claim 1, wherein the plurality of nanopores are formed in such a manner of anodizing an aluminum thin film in an electrolytic acid solution containing oxide.

7. The transparent light-emitting sheet of claim 2, wherein one quantum dot is formed within each nanopore of the transparent alumina sheet.

8. The transparent light-emitting sheet of claim 2, wherein the quantum dot is formed by metal organic chemical vapor deposition (MOCVD) or molecular beamepitaxy (MBE).

9. The transparent light-emitting sheet of claim 2, wherein the quantum dot is formed by chemical wetting of growing crystals by putting precursors in an organic solvent.

10. A method for manufacturing a transparent light-emitting sheet, comprising:
producing a transparent alumina sheet having a plurality of nanopores in a manner of anodizing an aluminum thin film in an electrolytic acid solution;
filling a predetermined amount of luminescent precursors within the plurality of pores; and
generating luminescent nanoparticles by applying heat to the luminescent precursors filled in the plurality of pores.

11. The method of claim 10, wherein the luminescent nanoparticles are quantum dots.

12. The method of claim 10, wherein the plurality of nanopores have a uniform size, a uniform shape and a uniform arrangement.

13. The method of claim 10, wherein the plurality of nanopores have one of a uniform size, a uniform shape and a uniform arrangement.

14. The method of claim 10, wherein the producing of the transparent alumina sheet comprises:
impregnating the aluminum thin film into the electrolytic acid solution containing oxide; and
forming the plurality of nanopores on the aluminum thin film in a manner of anodizing the aluminum thin film in the electrolytic acid solution.

15. The method of claim 11, wherein one quantum dot is formed in each nanopore of the transparent alumina sheet.

16. The method of claim 11, wherein the quantum dot is formed by metal organic chemical vapor deposition (MOCVD) or molecular beamepitaxy (MBE).

17. The method of claim 11, wherein the quantum dot is formed by chemical wetting of growing crystals by putting precursors in an organic solvent.
